(19) United States
(12) Patent Application Publication
(10) Pub. No.: US 2006/0270284 A1
(43) Pub. Date: Nov. 30, 2006

(54) AC power network LAN interface module

(76) Inventor: John J. Youden, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/140,671

(22) Filed: May 27, 2005

(51) Int. Cl. H01R 9/22

(52) U.S. Cl. 439/717

(57) ABSTRACT

A LAN interface module for a network on AC network has a housing. The housing has an AC jack, a network jack coupled by a network on AC conversion circuit to the AC jack, and an AC plug projecting outwardly therefrom configured to plug into an AC jack of a network device.

### FIELD OF THE INVENTION

The present invention relates to interface modules for interfacing network devices, such as desktop and notebook computers, printers, to AC power and a network where the network connectivity is provided over the AC power lines.

### BACKGROUND OF THE INVENTION

Local area networks (LANs) are commonly used networks. They are used to connect network devices, such as personal computers, notebook computers, printers, displays (such as monitors and televisions), etc., together, typically via a server(s). LANs can utilize various types of communication protocols, such as the Ethernet protocol. Typically, the network bus is separately wired and the various network devices are connected to it by cables running from the network devices to respective network jacks.

An alternative approach is to utilize the AC power lines to also carry the network signals. That is, using Ethernet as an example, electronics (that are known) are provided to provide Ethernet connectivity on the AC power lines.

In networks using Ethernet on power line functionality, interface modules, referred to herein as LAN interface modules, convert the Ethernet carrier signals on the power lines to conventional Ethernet signals and vice-versa. It should be understood that other types of data network communication protocols can be carried on the AC power lines and that the reference to the Ethernet protocol is by way of example and not of limitation. Data networks that utilize the AC power lines to carry the data network communication signals will be referred to generically herein as “network on AC” networks. These LAN interface modules use known electronic circuits to do this conversion. These LAN interface modules typically plug into power outlets, such as wall outlets, to which the power lines are connected. A LAN cable must then be run from the LAN interface module to the device, such as a personal computer. A power cord must also typically be run from a power outlet to the network device.

### SUMMARY OF THE INVENTION

A LAN interface module for a network on AC network has a housing. The housing has an AC jack, a network jack coupled by a network on AC conversion circuit to the AC jack, and an AC plug projecting outwardly therefrom configured to plug into an AC jack of a network device.

In an aspect of the invention, the AC plug of the LAN interface module is plugged into an AC jack of a network device and a network cable is plugged into the network jack of the LAN interface module and a network jack of the network device.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified schematic view of a LAN interface module and network device in accordance with an aspect of the invention.

### DETAILED DESCRIPTION OF THE PREFERRED EMBODIMENTS

The following description of the preferred embodiment(s) is merely exemplary in nature and is in no way intended to limit the invention, its application, or uses.

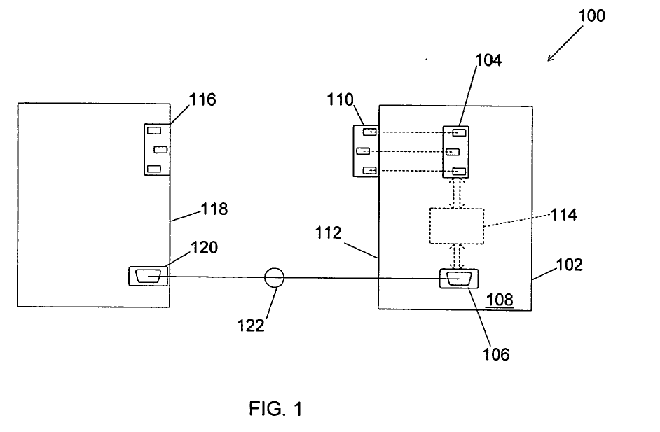

Referring to FIG. 1, a LAN interface module 100 in accordance with an aspect of the invention is described. LAN interface module 100 includes a housing 102. Housing 102 includes an AC jack 104 and an Ethernet jack 106 disposed in a sidewall 108 of housing 102. Housing 102 further includes an AC plug 110 extending outwardly from a rear wall 112. AC plug 110 is electrically connected to AC jack 104. AC plug 110 is illustratively a female plug and AC jack 104 is illustratively a male jack. AC plug 110 is configured or shaped to plug into an AC power jack 116 of network device 118. That is, the shape of AC plug 110 corresponds to the shape of the plug at the end of the AC power cord that typically plugs into the AC power jack 116 of the network device 118. A conversion circuit 114, referred to herein as “network on AC” conversion circuit 114, couples AC jack 104 to Ethernet jack 106. Network on AC conversion circuit 114 includes a known electronic circuit that converts the Ethernet on AC signals brought into AC jack 104 on the AC power lines to conventional Ethernet signals and vice-versa.

In use, AC plug 110 of LAN interface module 100 is plugged into the AC power jack 116 of network device 118. An Ethernet cable 122 is plugged into Ethernet jack 106 of LAN interface module 100 and into an Ethernet jack 120 of network device 118. A power cord (not shown) is plugged into AC jack 104 of LAN interface module 100 and into a power outlet (not shown) which provides AC power as well as Ethernet over AC on the power lines.

It should be understood that network device 118 can be any device that communicates with a network, and may include, by way of example and not of limitation, personal computers, notebook computers, printers, displays (such as monitors and televisions), and servers.

While the LAN interface module 100 has been described in the context of a network using the Ethernet protocol, it should be understood that it can be used with networks using other protocols.

LAN interface module 100, by plugging into the AC jack of the network device 118, is in series between the network device 118 and the AC power cord. It thus does not consume an additional power jack, such as a wall outlet. Also, due to the close physical proximity of LAN interface module 100 and Ethernet jack 120 of network device 118, only a short Ethernet cable is needed to connect Ethernet jack 106 of LAN interface module 100 to Ethernet jack 120 of network device 118 and this Ethernet cable is easily routed between LAN interface module 100 and network device 118. LAN interface module 100 also eliminates the need to run an Ethernet cable from an interface module at the power outlet. By doing so, it reduces or eliminates any confusion that might arise regarding which network device to plug the Ethernet cable into that runs from the interface module at the power outlet.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A LAN interface module for a network on AC network, comprising a housing having an AC jack, a network jack coupled by a network on AC conversion circuit to the AC jack, and an AC plug projecting outwardly therefrom configured to plug into an AC jack of a network device.

2. The apparatus of claim 1 wherein the network on AC network is an Ethernet on AC network.

3. In combination, a network device and a LAN interface module for a network on AC network, comprising:
the LAN interface module including a housing having an AC jack, a network jack coupled by a network on AC conversion circuit to the AC jack, and an AC plug projecting outwardly therefrom;
the network device including an AC jack and a network jack; and
the AC plug of the LAN interface module plugged into the AC jack of the network device.

4. The apparatus of claim 3 including a network cable plugged into the network jack of the LAN interface module and the network jack of the network device.

5. The apparatus of claim 4 wherein the network on AC network is an Ethernet network on AC.
